(19) United States
(12) Patent Application Publication
(10) Pub. No.: US 2007/0225890 A1
(43) Pub. Date: Sep. 27, 2007

(54) Parking Brake System Equipped With A Sensor

(76) Inventor: Manfred Ringlstetter, Weng (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/569,299

(22) PCT Filed: Mar. 1, 2005
(86) PCT No.: PCT/EP05/50872

§ 371 Date: Nov. 17, 2006

(30) Foreign Application Priority Data
May 18, 2004 (DE) 10 2004 024 652.1

(51) Int. Cl. G06G 7/76; B60L 7/00

(52) U.S. Cl. 701/70; 188/161; 188/162

(57) ABSTRACT

In an electronic parking brake system and to a method for controlling said system, to detect an undesired positional modification of an actuator (14) of the parking brake system during an inactive state of the controller (12), the latter is switched to an active state by a sensor (22). To generate the displacement signal (24), the sensor (22) only draws energy from the motion of the actuator (14) or from a modification of the magnetic field that is caused by the motion of the actuator (12).

### CROSS-REFERENCE TO RELATED APPLICATIONS

This application is a U.S. national stage application of International Application No. PCT/EP2005/050872 filed Mar. 1, 2005, which designates the United States of America, and claims priority to German application number DE 10 2004 024 652.1 filed May 18, 2004, the contents of which are hereby incorporated by reference in their entirety.

### TECHNICAL FIELD

The invention relates to an electronic parking brake system with at least one controller, at least one actuator, and at least one sensor.

### BACKGROUND

The invention further relates to a method for controlling an electronic parking brake system having at least one controller, at least one actuator, and at least one sensor.

Electronic parking brake systems are increasingly replacing the purely manual handbrakes in motor vehicles. The use of electronic parking brake systems eliminates the usually relatively large control lever located in the passenger compartment, thereby allowing much greater freedom in designing the passenger compartment layout. In addition, such a system offers greater operating convenience, as on the one hand the user does not need to exert any great force to apply or release the brake, and on the other hand various functions such as hill starts or releasing the brake when moving off for the first time after parking can be electronically and therefore also automatically performed. However, these advantageous features of an electronic parking brake system must be accompanied by comparable or improved safety relative to the purely mechanical handbrake and an acceptable quiescent power consumption.

In general, an electronic parking brake is either in “parking brake applied” or “parking brake released” status. For this purpose a controller monitors the position of an actuator by means of position signals which can be derived from an absolute value and, for example, initiates a changeover from one status to the other in response to a corresponding user input. In order to effect such a changeover, the controller must be in a first operating state in which the position signals are detectable by it. There is additionally provided a second operating state of the controller in which said position signals are not detectable by it. This operating state may be assumed, for example, if low power consumption is required while the ignition is off. If the actuator changes position during said second controller operating state, this is not detected by the controller and the parking brake assumes a fault status “position not known/uncalibrated”.

In order to enable the parking brake's current status—“parking brake applied” or “parking brake released”—to be identified when the controller switches from the second operating state to the first operating state in which the actuator position changes are detectable, a so-called calibration run can be initiated during which the actuator is moved until the controller detects that a calibration mark has been attained. However, the disadvantage of this procedure is that a calibration run has to be performed every time the controller switches from the second to the first operating state.

Alternatively, the status identification problem could be solved by additional monitoring of the actuator position, e.g. by resistive position transducers. Here, however, it is not possible for the controller, on leaving the known status, to respond immediately with appropriate actions, as it cannot act until it returns to the first operating state in which it again detects the actuator's position signals.

### SUMMARY

The exists a need to eliminate the disadvantages of the prior art and, in particular, to provide an apparatus and a method which enables the controller to switch from the first to the second operating state with low quiescent energy consumption.

An electronic parking brake may comprise at least one controller, at least one actuator and at least one sensor, wherein position signals of the actuator are detectable by the controller in a first operating state and are not detectable by the controller in a second operating state, wherein a position change of the actuator causes a change in the magnetic field in the vicinity of the sensor, a change in the magnetic field in the vicinity of the sensor generates an induction voltage detectable as a movement signal, and the controller is designed such that it can be switched from the second to the first operating state by the movement signal.

According to an embodiment, the sensor may be a pulse wire sensor. According to an embodiment, a magnetic field generating device for varying the magnetic field in the vicinity of the sensor can be moved by the actuator. According to an embodiment, the magnetic field generating device can be a rotor assigned to the actuator, the rotor likewise being designed to generate the position signals. According to an embodiment, the magnetic field generating device may incorporate a magnet which is provided in addition to a rotor, the rotor being provided to generate the position signals. According to an embodiment, the controller may incorporate a microcontroller whose power consumption in the second operating state is in the order of 10 μA.

A method for controlling an electronic parking brake having at least one controller, at least one actuator and at least one sensor, may comprise the steps of: detecting position signals of the actuator in a first operating state and are not detected in a second operating state, causing a change in the magnetic field in the vicinity of the sensor by a position change of the actuator, generating an induction voltage detectable as a movement signal by a change in the magnetic field in the vicinity of the sensor, and causing the controller to go from the second to the first operating state by the movement signal.

According to an embodiment, the change in the magnetic field may be detected by a pulse wire sensor. According to an embodiment, the actuator may move a magnetic field generating device to vary the magnetic field in the vicinity of the sensor.

### BRIEF DESCRIPTION OF THE DRAWINGS

The invention will now be explained using examples of preferred embodiments with reference to the accompanying drawings in which:

FIG. 1 shows a functional block diagram to explain an apparatus according to the invention; and

FIG. 2 shows a flowchart to explain a method according to the invention.

### DETAILED DESCRIPTION

According to an embodiment there is provided an electronic parking brake having at least one controller, at least one actuator and at least one sensor, wherein actuator position signals are detectable by the controller in a first operating state and are not detectable by the controller in a second operating state, an actuator position change can cause a change in the magnetic field in the vicinity of the sensor, a change in the magnetic field in the vicinity of the sensor can generate an induction voltage detectable as a movement signal, and the controller can be switched from the second to the first operating state by the movement signal. If a magnetic field in which a sensor equipped with electrically conductive material is located changes, a charge separation takes place in the electrically conductive material because of the Lorentz force acting on the charge carriers. This effect is known as magnetic induction, and the voltage present is termed the induction voltage. To produce this effect no initial current flow is necessary, a change in the magnetic field and therefore a movement of the magnetic field lines relative to the charge carriers sufficing. An actuator position change mediated by a magnetic field can therefore produce an induction voltage which, as a movement signal, switches the controller from the second to the first operating state and enables actuator position signals to be detected. The magnetic field can be provided without energy consumption, the energy for producing the movement signal coming from the movement of the actuator itself. This therefore constitutes an apparatus which, in the event of an impending departure from a known parking brake status, enables the controller to switch in an energy saving manner from the second operating state in which it does not detect a departure of this kind to the first operating state in which the controller again receives actuator position signals and can respond accordingly.

According to an embodiment, the sensor is a pulse wire sensor. A pulse wire sensor, also known as a Wiegand sensor, employs the so-called Barkhausen effect, i.e. if in the event of change in the ambient magnet field a magnetic field strength limit value is exceeded, abrupt re-magnetization takes place inside the pulse wire sensor. The abrupt magnetic field change in turn induces an induction voltage detectable as a movement signal. Overall the induction principle explained above is therefore used indirectly via the Barkhausen effect. The pulse wire sensor has the advantage that it supplies a fixed-height signal that is particularly suitable for integrated circuits.

The apparatus according to an embodiment can be further developed by a magnetic field generating device being movable by the actuator to vary the magnetic field in the vicinity of the sensor. The magnetic field generating device directly varies the magnetic field in the vicinity of the sensor, resulting in direct coupling between the position change of the actuator and its movement signal.

In particular, with the apparatus according to an embodiment it can be provided that the magnetic field generating device is a rotor assigned to the actuator, the rotor being likewise designed to generate the position signals. Using the rotor both to generate the position signal and to generate the movement signal reduces the production and design costs for manufacturing such an apparatus.

Alternatively the apparatus according to an embodiment can be implemented in such a way that the magnetic field generating device incorporates a magnet which is provided in addition to a rotor, the rotor being designed to generate the position signals. If the apparatus comprises a magnet in addition to the rotor provided to generate the position signals, generation of the movement signal is decoupled from that of the position signal. This is clearly particularly advantageous in terms of safety, and the additional magnet can be optimized for its purposes.

Moreover, in one embodiment it can be provided that the controller incorporates a microcontroller whose power consumption in the second operating state is in the order of 10 pA. In this way the controller's energy consumption is kept very low in the second operating state for detecting the movement signal.

The invention additionally provides a method for controlling an electronic parking brake having at least one controller, at least one actuator and at least one sensor, wherein the controller detects actuator position signals in a first operating state and does not detect them in a second operating state, an actuator position change causes a change in the magnetic field in the vicinity of the sensor, a change in the magnetic field in the vicinity of the sensor produces an induction voltage detectable as a movement signal, and the controller is switched from the second to the first operating state by said movement signal. The method according to the invention is likewise based on the above explained principle of magnetic induction of an induction voltage in an electrically conductive material due to a change in a magnetic field permeating the electrically conductive material and also implements the advantages and features of the apparatus according to the invention in terms of a method. This also applies to the particularly preferred embodiments of the method according to the invention that are described below.

The method can be further developed in that the magnetic field change is detected by a pulse wire sensor. In addition, it can be provided according to another embodiment that the actuator moves a magnetic field generating device to vary the magnetic field in the vicinity of the sensor.

A motor vehicle may have an electrical parking brake system. The invention is based on the idea of detecting the movement of an actuator using a pulse wire sensor. The movement signal supplied by the pulse wire in the form of a voltage pulse is sufficient to place the controller in the first, active operating state, thereby enabling it to respond according to the stored safety concept, no additional (quiescent) power source being required apart from the power supply for a microcontroller in the order of 10 pA.

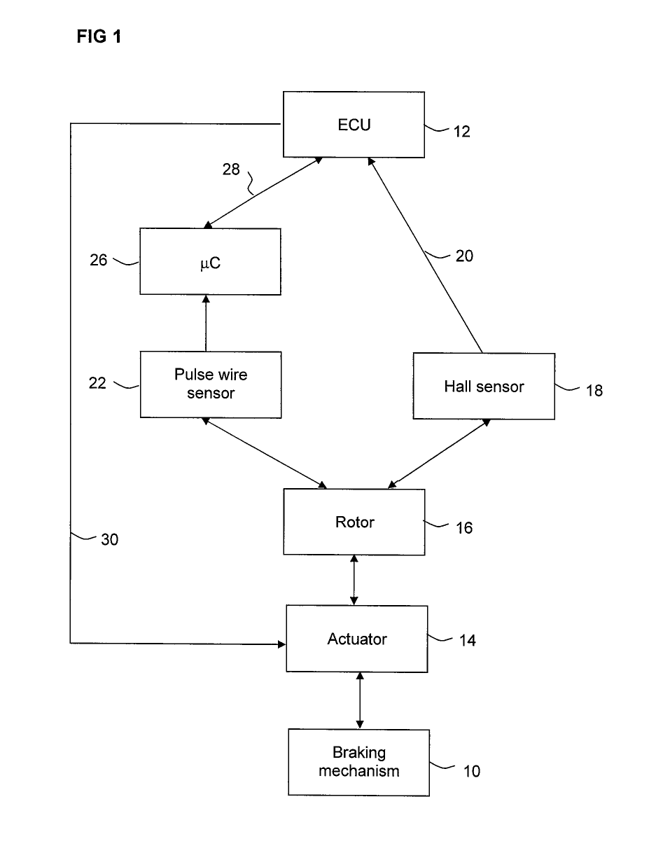

FIG. 1 shows a functional block diagram to explain an apparatus according to the invention. In addition to the electronic, mechanical and in some cases hydraulic components known from the prior art, here subsumed under the term braking mechanism 10, the version illustrated has an electronic control unit (ECU) 12 and an actuator 14. The electronic control unit 12 controls the movements of the actuator 14 which is operatively connected to the braking mechanism 10. A rotor 16 detects the movements of the actuator 40 and converts them into corresponding magnetic field variations. The movements of the rotor 16 and the accompanying changes in the magnetic field are detected by a Hall sensor 18 and provided to the electronic control unit 12 as position signals 20. In addition, the changes in the magnetic field caused by the rotor 16 are detected by a pulse wire sensor 22. The latter forwards corresponding movement signals 24 to a microcontroller (μC) 26, whereupon the microcontroller 26 sends a wake-up signal 28 to the electronic control unit 12.

If the electronic control unit 12 is in an active operating state, it controls the actuator 14 using control signals 30 and can thus place the parking brake in both “parking brake is applied” and “parking brake is released” status. If the electronic control unit 12 is in standby mode, it can detect each movement of the actuator 14 with the aid of the rotor 16 and the Hall sensor 18, thereby enabling the status currently obtaining to be detected and stored. Alternatively, the status of the actuator or rather the entire parking brake system could be detected via force measurement, current measurement or other analog or digital signals.

If the electronic control unit 12 is in sleep mode, it is not advantageous for the movement of the actuator 14 to be detected by means of the rotor 16 and Hall sensor 18, as the Hall sensor 18 should not be operated because of the high quiescent current consumption in sleep mode. In this case, a movement of the actuator 14, which can be produced e.g. by actuating the mechanical emergency release device (not shown) or by workshop personnel, is detected by the pulse wire sensor 22. When the actuator 14 is moved, because of the mechanical coupling the rotor 16 is likewise moved and therefore produces a change in the magnetic field in the vicinity of the pulse wire sensor 22. If the magnetic field strength present at the pulse wire sensor 22 exceeds a specified limit value—which can be continuously ensured by a corresponding geometrical configuration—the wire core comprising a single magnetic domain is abruptly re-magnetized in an elementary process wherein, depending on the design of the sensor, an induction voltage of approximately 3-4 V and 10 μs duration is induced. The pulse amplitude and duration are independent of the rate of change of the varying magnetic field. The voltage pulse thus produced is forwarded to the microcontroller 26 as a movement signal 24. By means of a wake-up signal 28, the microcontroller 26 switches the electronic control unit 12 from sleep mode to standby mode, thereby enabling the position changes of the actuator 14 to be detected via the Hall sensor 18. In particular, the electronic control unit 12 can thus react according to a stored safety concept and prevent the electronic parking brake from switching to an uncalibrated state.

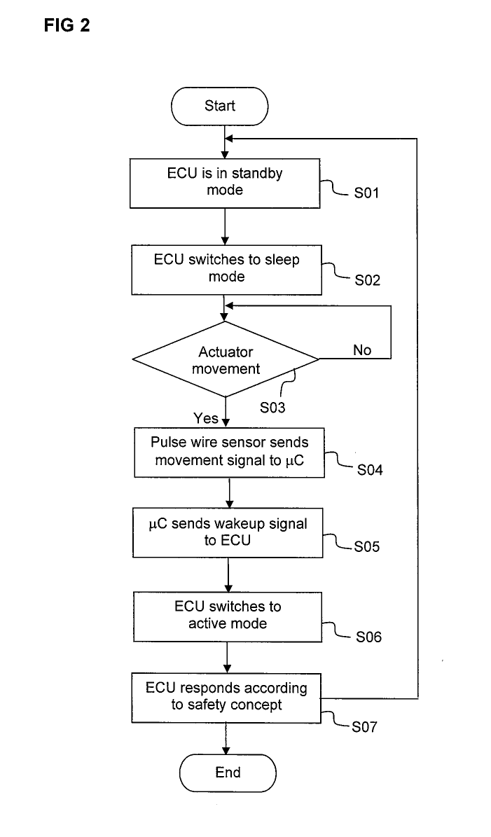

FIG. 2 shows a flowchart to explain the method according to the invention. The description of the method according to the invention begins at the point in time when the electronic control unit (ECU) changes over from standby mode to sleep mode. This is represented by steps S01 and S02; in step S01 the electronic control unit is in standby mode, in step S02 it switches to sleep mode. The process pauses at this point until sleep mode is terminated e.g. either by an ignition sequence or a request from a central monitoring unit (not shown) or the process moves on to step S04 due to an actuator movement S03 and an associated magnetic field change in the vicinity of the pulse wire sensor. Here due to the magnetic field change in the pulse wire sensor a voltage pulse is produced which is forwarded to the microcontroller as a movement signal. As soon as the microcontroller has received a movement signal, it generates a wake-up signal and sends it to the electronic control unit. This is shown in step S05. On receiving the wake-up signal, the electronic control unit then switches in step S06 to an active mode in which the actuator movements are again detectable as position signals by means of the Hall sensor. From this active mode, in step S07 the electronic control unit can respond according to the stored safety concept and immediately place the mechanism in a safe state. On completion of the safety procedure, the method according to the invention terminates and the electronic control unit can again change to standby mode with step S01 provided no other procedures are planned.

An electronic parking brake system and a method for controlling same are disclosed, wherein to detect an unwanted position change of the actuator 14 of the parking brake system during an inactive state of the controller 12, same is placed in an active operating state by a sensor 22, said sensor 22 deriving the energy for generating the movement signal 24 solely from the movement of the actuator itself or rather from a magnetic field change caused by the movement of the actuator 12.

The features of the invention disclosed in the above description, in the drawings and in the claims may be constitutive of the invention both individually and in any combination.

What is claimed is:

1. An electronic parking brake comprising at least one controller, at least one actuator and at least one sensor, wherein position signals of the actuator are detectable by the controller in a first operating state and are not detectable by the controller in a second operating state, wherein a position change of the actuator causes a change in the magnetic field in the vicinity of the sensor, a change in the magnetic field in the vicinity of the sensor generates an induction voltage detectable as a movement signal, and the controller is designed such that it can be switched from the second to the first operating state by the movement signal.

2. The electronic parking brake system according to claim 1, wherein the sensor is a pulse wire sensor.

3. The electronic parking brake system according to claim 1, wherein
a magnetic field generating device for varying the magnetic field in the vicinity of the sensor is moved by the actuator.

4. The electronic parking brake system according to claim 1, wherein the magnetic field generating device is a rotor assigned to the actuator, the rotor likewise being designed to generate the position signals.

5. The electronic parking brake system according to claim 1, wherein the magnetic field generating device incorporates a magnet which is provided in addition to a rotor, the rotor being provided to generate the position signals.

6. The electronic parking brake system according to claim 1, wherein the controller incorporates a microcontroller whose power consumption in the second operating state is in the order of 10 μA.

7. A method for controlling an electronic parking brake having at least one controller, at least one actuator and at least one sensor, the method comprising the steps of:
detecting position signals of the actuator in a first operating state and are not detected in a second operating state,
causing a change in the magnetic field in the vicinity of the sensor by a position change of the actuator,
generating an induction voltage detectable as a movement signal by a change in the magnetic field in the vicinity of the sensor and
causing the controller to go from the second to the first operating state by the movement signal.

8. The method according to claim 7, wherein
the change in the magnetic field is detected by a pulse wire sensor.

9. The method according to claim 7, wherein
the actuator moves a magnetic field generating device to vary the magnetic field in the vicinity of the sensor.

10. An motor vehicle having an electronic parking brake comprising at least one controller, at least one actuator and at least one sensor, wherein
the controller is operable in a first and second operating state,
the controller detects position signals of the actuator in the first operating state and does not detect position signals in a second operating state,
a position change of the actuator causes a change in the magnetic field in the vicinity of the sensor,
the sensor generates a sensor signal due to a change in the magnetic field in the vicinity of the sensor, and the controller is designed such that it is switched from the second to the first operating state by the sensor signal.

11. The motor vehicle according to claim 10, wherein the sensor is a pulse wire sensor.

12. The motor vehicle according to claim 10, wherein a magnetic field generating device for varying the magnetic field in the vicinity of the sensor is moved by the actuator.

13. The motor vehicle according to claim 10, wherein the magnetic field generating device is a rotor assigned to the actuator, the rotor likewise being designed to generate the position signals.

14. The motor vehicle according to claim 10, wherein the magnetic field generating device incorporates a magnet which is provided in addition to a rotor, the rotor being provided to generate the position signals.

15. The motor vehicle according to claim 10, wherein the controller incorporates a microcontroller whose power consumption in the second operating state is in the order of 10 μA.
